(19) United States
(12) Patent Application Publication
(10) Pub. No.: US 2025/0167453 A1
(43) Pub. Date: May 22, 2025

(54) SPACE-TIME MULTIPORT ANTENNA SYSTEM

(71) Applicant: The Hong Kong University of Science and Technology, Hong Kong (CN)

(72) Inventors: Ross David MURCH, Hong Kong (CN); Chi Yuk CHIU, Hong Kong (CN)

(21) Appl. No.: 18/942,814

(22) Filed: Nov. 11, 2024

Related U.S. Application Data
(60) Provisional application No. 63/602,342, filed on Nov. 22, 2023.

(51) Int. Cl. H01Q 9/04; H01Q 1/52; H01Q 5/314; H01Q 21/24

(52) U.S. Cl. CPC H01Q 9/0421; H01Q 1/521; H01Q 5/314; H01Q 9/045; H01Q 21/24

(57) ABSTRACT

A space-time multiport antenna system is provided. The space-time multiport antenna system includes an antenna array, a plurality of feed ports, and a controller. The antenna array includes a plurality of antenna elements. The feed ports are connected to the antenna elements, respectively. The controller is connected to the antenna array via the feed ports and configured to control the antenna elements for dynamically switching states of the antenna elements. Each pair of the adjacent antenna elements form a unit, and, in anyone of the units and at any given time, only one of the antenna elements is active and another one of the antenna elements is in a non-active state. The proposed controller can be applied to different types of antennas, providing a general technique to reduce mutual coupling of closely-spaced antennas significantly.

### TECHNICAL FIELD

The present invention generally relates to an antenna system. More specifically, the present invention relates to a space-time multiport antenna system.

### BACKGROUND

The use of multiple-input multiple-output (MIMO) in wireless communications has revolutionized communication performance by enabling increases in data rates without requiring more bandwidth or power. At high signal-to-noise ratios (SNRs), increases in MIMO capacity is proportional to the number of transmitter antennas (under the condition the receiver side has the same or more antennas), and is now included in nearly all wireless communication systems. In future wireless systems, such as 6G, MIMO will most certainly be included as one of the backbone technologies where there will be ongoing demand for further enhancements to MIMO capacity. As part of this, MIMO antenna design is even more critical than ever, so that more antennas at both the base and mobile stations can be utilized to increase capacity further.

In future base station antennas, massive MIMO systems have been envisaged, where up to 1000 antenna elements have been proposed. A critical design requirement in these designs is therefore the element density, or elements per square wavelength. On the other hand, at the mobile station, size is a major constraint, and thus the development of compact multiport antennas remains an important research topic. While fundamental limits to the number of antennas that can be placed in a certain area or volume exist, practical multiport designs with large numbers (significantly more than two) of antennas are still not reaching that limit. It is therefore of significant interest to develop novel approaches to multiple antenna design that can reach the predicted limits.

On the other hand, the use of time as a 4th dimension in antenna design has also been exploited in a variety of applications. Space-time antenna design in the form of time modulated arrays (TMAs) is one application that has been widely investigated. TMA has been shown to provide significant advantages in terms of radiation pattern control.

However, the direct use of space-time design in MIMO antennas has been limited. One reason for this is that harmonic generation in space-time antenna systems is very difficult to manage and is in direct conflict with the need for wireless systems to operate within a specific frequency allocation.

Therefore, although multiport antennas are a key component in MIMO wireless communication systems, the growing demand for higher data throughputs and enhanced communication performance continues to drive research into future wireless systems. As a result, a renewed focus on the design of multiport antennas is necessary to push the boundaries of MIMO system capabilities and achieve even greater performance enhancements.

### SUMMARY OF INVENTION

It is an objective of the present invention to provide methods and apparatuses to address the aforementioned shortcomings and unmet needs in the state of the art.

In the present invention, the objective is to use space-time antenna design techniques for providing novel multiport antenna designs that can provide enhanced wireless communication performance. The key novelty is to exploit time modulation inside the antenna to significantly reduce the effects of mutual coupling. The proposed approach has the potential to quadruple the number of antennas that can be placed in a two-dimensional area without violating any fundamental limits. As such harnessing the fourth dimension, time, in multiport antenna design may open up new possibilities for providing enhanced wireless communication performance. While space-time design has been proposed previously in the design of antenna systems, such as time modulated array (TMA) antennas, its use in the design of multiport antennas has not been widespread.

In the present invention, multiport antennas based on space-time design are referred to as time-modulated multiport (TMM) antennas. A particular challenge in using time modulation in the design of antennas for wireless communication is the bandwidth expansion caused by harmonic generation.

In accordance with the first aspect, a space-time multiport antenna system is provided. The space-time multiport antenna system includes an antenna array, a plurality of feed ports, and a controller. The antenna array includes a plurality of antenna elements. The feed ports are connected to the antenna elements, respectively. The controller is connected to the antenna array via the feed ports and configured to control the antenna elements for dynamically switching states of the antenna elements. Each pair of the adjacent antenna elements form a unit, and, in anyone of the units and at any given time, only one of the antenna elements is active and another one of the antenna elements is in a non-active state. In some embodiments, the antenna array is formed by arranging the antenna elements into a N*M array, wherein N and M are positive integers greater than one.

In accordance with the second aspect, a space-time multiport antenna system is provided. The space-time multiport antenna system includes a dual-polarized antenna, a plurality of feed ports, and a controller. The dual-polarized antenna array comprises a plurality of antenna elements. Each of the antenna elements is in a crossed dipole structure and comprises a first dipole element extending horizontally along a first axis direction and a second dipole element extending vertically along a second axis direction, forming an orthogonal configuration at their intersection. In each of the antenna elements, the first dipole element is made of a conductive material aligned along a horizontal plane and the second dipole element is made of a conductive material aligned along a vertical plane, with the first dipole element and the second dipole element being spatially intersecting but electrically isolated. Each of the first dipole elements and the second dipole elements is connected to a corresponding one of the feed ports, enabling independent transmission and reception of horizontally or vertically polarized signals. The controller is connected to the dual-polarized antenna array via the feed ports and is configured to control the antenna elements for dynamically switching states of the antenna elements, in which each pair of the adjacent antenna elements form a unit and the two of the adjacent antenna elements in the unit are active at any given time, but their respective dipole elements operate in differing states.

In accordance with the third aspect, a method for operating a space-time multiport antenna system is provided. The method includes steps as follow: feeding horizontally or vertically polarized signals to a dual-polarized antenna array via feed ports, wherein the dual-polarized antenna array comprises a plurality of antenna elements, each of the antenna elements is in a crossed dipole structure and comprises a first dipole element extending horizontally along a first axis direction and a second dipole element extending vertically along a second axis direction, forming an orthogonal configuration at their intersection, and wherein each pair of the adjacent antenna elements form a unit; and controlling the dual-polarized antenna array using the controller via the feed ports for dynamically switching states of the antenna elements, such that the two of the adjacent antenna elements in the unit are active at any given time, but their respective dipole elements operate in differing states.

In accordance with the fourth aspect, an antenna system is provided. The antenna system includes a first planar inverted-F antenna (PIFA) element and a second PIFA element, at least one feed pin, and a controller. The first PIFA element and the second PIFA element are arranged in parallel, in which the first PIFA element extends in a first direction and the second PIFA element extends in a second direction opposite to the first direction. The feed pin is electrically connected to the first and second PIFA elements, in which the feed pin is configured to receive or transmit signals for the first and second PIFA elements. The controller is connected to the first and second PIFA elements via the feed pin and is configured to dynamically control an operational state for the first and second PIFA elements. At a first time point, the first PIFA element is active and the second PIFA element remains inactive; and, at a second time point, the second PIFA element is active and the first PIFA element remains inactive, allowing for controlled switching between the first and second PIFA elements based on time-modulated operation.

In some embodiments, the first PIFA element and the second PIFA element are arranged in parallel and extend in the same direction.

Although the above examples use dual-polarized antennas and PIFA antennas, the present invention is not limited to these. The controller can also be applied to other types of antennas.

The importance of the proposed TMM antenna approach lies in its potential application for future wireless communication systems. As 6G development progresses, concepts like extreme massive MIMO arrays, centimeter MIMO arrays, and holographic MIMO are being explored. To enable these advancements, new multiport antenna designs will be required to meet the increasing demands of MIMO.

### BRIEF DESCRIPTION OF DRAWINGS

Embodiments of the invention are described in more details hereinafter with reference to the drawings, in which:

FIG. 1A and FIG. 1B depict the concept of time-modulated antennas (TMAs);

FIG. 2 depicts an antenna design of a two-port planar inverted-F antenna (PIFA) utilized operating at 2.6 GHz according to one embodiment of the present invention;

FIG. 3A and FIG. 3B show simulation results for the two-port antenna design in FIG. 2 when both ports are loaded and are therefore in the “on” state;

FIG. 4A and FIG. 4B show simulation results for the two-port antenna design in FIG. 2 with an open circuit at port 2;

FIG. 5A and FIG. 5B show antenna patterns along x-z cut with both ports loaded;

FIG. 6A and FIG. 6B show open circuit antenna patterns along x-z cut;

FIG. 7A depicts a schematic drawing of a space-time multiport antenna system according to some embodiments of the present invention;

FIG. 7B depicts a schematic drawing of a dual-polarized antenna during operation according to some embodiments of the present invention; and

FIG. 8 depicts a schematic drawing of a planar inverted-F antenna system according to some embodiments of the present invention.

### DETAILED DESCRIPTION OF THE INVENTION

In the following description, space-time multiport antenna systems and methods applying the same and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

In the present invention, the overarching objective is to utilize space-time antenna design to develop multiport antennas with enhanced wireless communication performance. Several inventive features are proposed for contributing to higher antenna densities. The proposed antenna systems are referred to as time-modulated multiport (TMM) antennas in the present disclosure.

First, explanations for space-time antenna design and multiport antenna design are provided.

### Space-Time Antenna Design

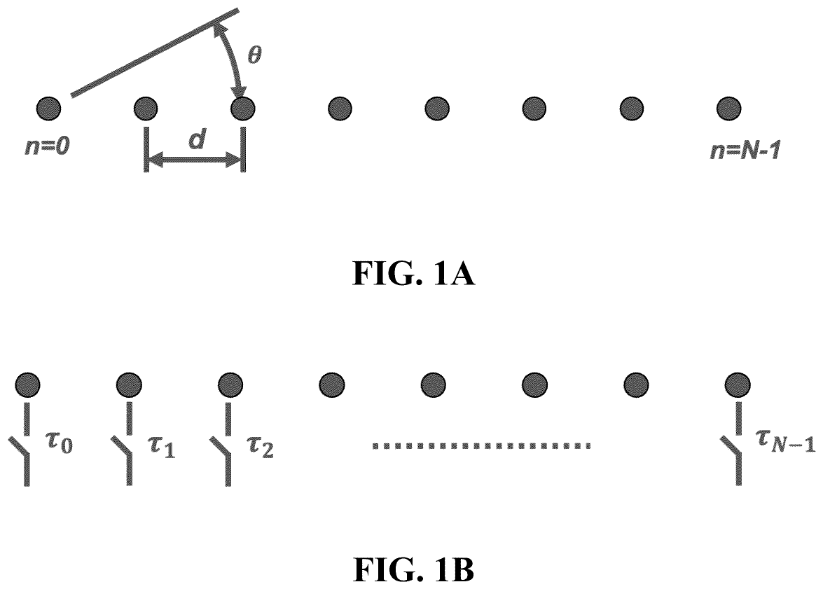

A key application of space-time design is in TMA which provides a straightforward technique for beamforming utilizing switches. FIG. 1A and FIG. 1B depict the concept of time-modulated antennas (TMAs). Specifically, FIG. 1A shows an antenna array with N elements spaced by spacing d, while FIG. 1B illustrates the placement of switching elements between the feed and the antenna elements to control the radiated pattern. The switches are modulated with a periodic signal of period T, and within each cycle, the elements are connected to the feed for a time duration of τₙ.

As shown in FIG. 1A and FIG. 1B, N-element array with element separation d, radiating in direction θ is controlled by switches placed between the feeds and antennas. The resulting radiation pattern is as follows:

$$E ( θ , ϕ , t ) ∝ e ( θ , ϕ ) {\sum }_{n = 0}^{N - 1} {a}_{n} {e}^{- j [ 2 π ft + nkdcos θ ]}$$

where θ, ϕ are spatial angles, e(θ, ϕ) is the pattern of a single element, k is wavenumber, f is frequency and aₙ are the element weights that are controlled by the switches. Turning on each element switch periodically for τₙ, out of a periodic switching period T, results in a radiation pattern with frequency harmonics; and, the resulting radiation pattern can be written as follows:

$$E ( θ , ϕ , t ) ∝ e ( θ , ϕ ) {\sum }_{m = - ∞}^{m = ∞} {e}^{j ( 2 π f + m / T ) t} {\sum }_{n = 0}^{N - 1} {a}_{m n} {e}^{- jnkdcos θ}$$

where

$${a}_{m n} = \frac{1}{T} {\int }_{0}^{{τ}_{n}} {e}^{j 2 π mt / T} dt .$$

Taking the first harmonic can provide the pattern:

$$E ( θ , ϕ , t ) ∝ e ( θ , ϕ ) {e}^{j 2 π ft} {\sum }_{n = 0}^{N - 1} \frac{{τ}_{n}}{T} {e}^{- jnkdcos θ}$$

where it can be seen the switch on time directly controls the antenna weights and provides an exceptionally straightforward method for beam control.

One key disadvantage of TMA is the creation of the radiation harmonics and this has meant the approach has not found wide spread application in wireless communications where bandwidth control is critical.

One key observation in TMA has been that the harmonics are mainly a concern at the transmitter as they are radiated into space. At the receiver the harmonics can be easily filtered out and do not cause a bandwidth problem. Therefore, single-RF TMA receivers have been proposed where harmonics at the receiver are utilized as beams. While there is a large body of research on TMA, the use of space-time antenna design in wireless communication applications still has challenges including: 1) How to apply space-time design to the development of multiport antenna systems; and 2) How to handle the frequency harmonics resulting from switching in time modulation.

### Multiport Antenna Design

Multiport antenna design has become an area of immense interest following the development of MIMO wireless communication systems. This interest is further enhanced by advancements in multi-user MIMO. Subsequently, massive MIMO has been developed and has become a cornerstone of current and future wireless systems.

To meet the demand for MIMO wireless systems, one of the key components is the development of compact multiport antennas.

A long line of techniques has been developed to reduce coupling between antenna elements and provide compact multiport antenna designs. These techniques generally fall into two categories. The first involves designs that feature low coupling currents, such as orthogonally polarized antennas and characteristic mode-based designs. Furthermore, this approach includes novel geometries that suppress coupling currents, such as defected ground structures (DGS), electromagnetic band-gap (EBG) structures, which were later generalized to electromagnetic metamaterials (MTM), split-ring resonators, and negative-electric MTM. The second approach uses alternative coupling paths to cancel the original coupling path, with techniques that include neutralization lines (NL), parasitic structures, and decoupling networks (DN). One issue with these approaches is achieving wideband performance.

In addition to MIMO antenna design, there have been developments regarding the fundamental size limits or port densities that can be achieved by multiport antennas. It has recently been shown that 18 ports per square wavelength with high isolation is an upper bound. Few designs have reached this density, making it an area of ongoing research. The few designs that have reached this limit remain impractical, either requiring specialized reactance components for their implementation or being unsuitable for integration into wireless devices due to bandwidth or geometric restrictions.

Design challenges for MIMO antennas still exist, including: 1) providing practical designs that can achieve the reported fundamental limits; and 2) developing new techniques to reduce mutual coupling.

Based on the above, a solution for MIMO antennas is provided according to various embodiments of the present invention, as described below. In the present disclosure, the methodology for utilizing space-time antenna design for developing compact TMM antennas is presented. The proposed solution is divided into five objectives, including:
1) Understanding system tradeoffs for TMM antennas;
2) Development of TMM antenna design guidelines;
3) Development of reconfigurable approaches to TMM antennas;
4) Investigation of extensions to transmit TMM antenna systems;
5) Validation of the TMM antenna designs;

The proposed design concept and exemplary results are provided to crystalize the proposed approach to TMM antenna design.

### (I): Design Concept and Exemplary Results for TMM Antennas

The design concept is to extend the time modulation of the antenna feeds for element weight control to the control of mutual coupling.

The basic idea uses the observation that if adjacent antenna elements are never allowed to be simultaneously in the “on” state (the “on” state is used here to define when the antenna port is connected to their respective receiver or transmitter), then the effect of mutual coupling can be significantly reduced. This concept is based on the property that antenna elements that are open circuited will not have an impact on an adjacent element. This is most straightforwardly appreciated by considering an N×N multiport impedance model of the antenna as:

$$[ \begin{matrix}{V}_{1} \\ ⋮ \\ {V}_{N}\end{matrix} ] = [ \begin{matrix}{Z}_{11} & … & {Z}_{N 1} \\ ⋮ & ⋱ & ⋮ \\ {Z}_{1 N} & … & {Z}_{NN}\end{matrix} ] [ \begin{matrix}{I}_{1} \\ ⋮ \\ {I}_{N}\end{matrix} ] \qquad Equation ( 1 )$$

where Vₙ and Iₙ are the voltage and current on antenna port n while Zₘₙ is the antenna impedance matrix. Note that all quantities are frequency dependent but we have dropped that from the notation for convenience.

If all ports in an antenna system in Equation (1) are left open, except for “port (1),” then the impedance seen at “the port (1)” will only be Z₁₁ and no mutual coupling will be experienced because all other ports are open. This is the principle intended to be exploited in the design of TMM antennas in the present invention. That is, antennas with adjacent ports will never be simultaneously time modulated to be on together. Therefore, mutual coupling effects from adjacent antennas will be completely removed. While the effect of mutual coupling will be removed there are tradeoffs including power and harmonic issues and these are addressed in the first objective as explained earlier.

To verify the basic concept, exemplary simulations have also been performed.

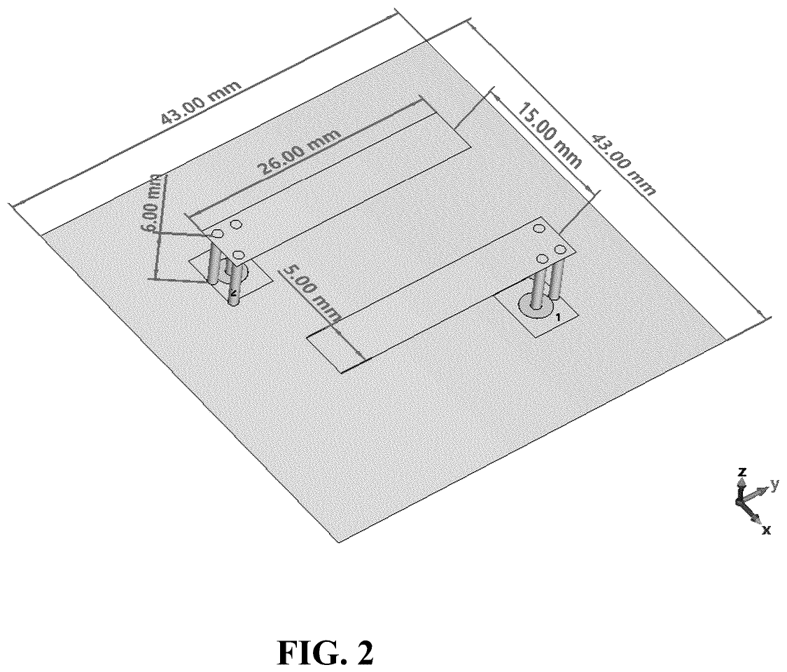

FIG. 2 depicts an antenna design of a two-port planar inverted-F antenna (PIFA) utilized operating at 2.6 GHz according to one embodiment of the present invention. The PIFA have very low separation to demonstrate the effects of mutual coupling. As shown in FIG. 2, the geometry for a basic two-port PIFA design operating at 2.6 GHz, assuming perfect conductors for testing purposes, is provided. In the illustration, it can be seen that the two antennas are spaced only 15 mm apart (less than 0.2 wavelengths) and therefore mutual coupling effects will be significant. Computer Simulation Technology (CST) studio simulations have then been performed.

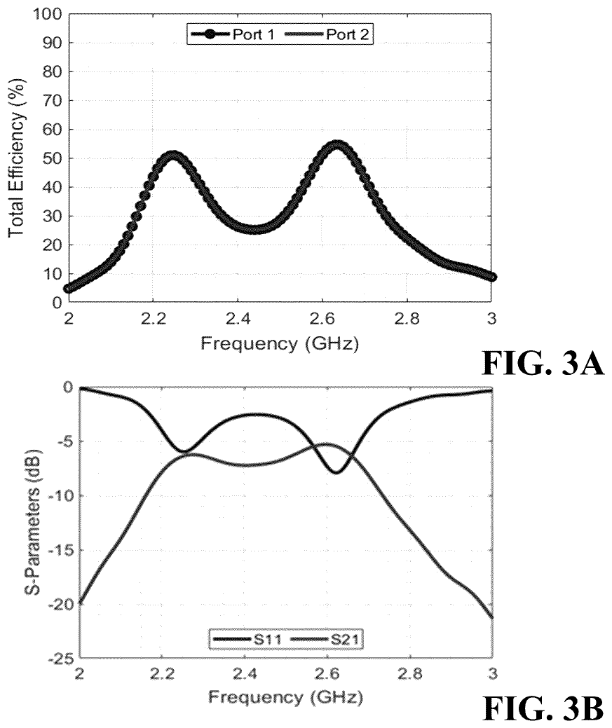

FIG. 3A and FIG. 3B show simulation results for the two-port antenna design in FIG. 2 when both ports are loaded and are therefore in the “on” state. Specifically, In FIG. 3A, it can be seen that efficiency is poor. From FIG. 3B, it can be seen that mutual coupling S₁₂ is poor (the lines for S₁₁, S₂₂ and S₁₂, S₂₁ overlap due to the symmetry of the design). Both of these results are due to the high mutual coupling between ports. Further, in FIG. 3A and FIG. 3B, the efficiency and S-parameter results are provided for when both ports are fed and loaded normally with 50 ohms. As can be seen efficiency is poor at around 50% due to the coupling between antennas. In addition, from the S-parameters, it can be seen that S₁₂ isolation is poor at around 6 dB. This result is expected because the mutual coupling between ports causes significant power to be returned to the adjacent source reducing efficiency.

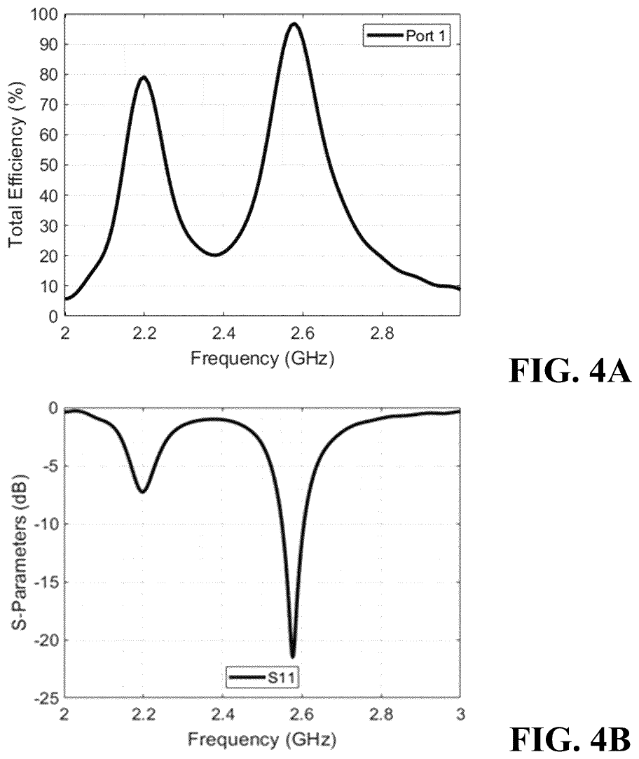

FIG. 4A and FIG. 4B show simulation results for the two-port antenna design in FIG. 2 with an open circuit at port 2. From FIG. 4A, it can be seen that efficiency is excellent as predicted by equation (1). This is due to the open circuited port removing the effect of mutual coupling. From FIG. 4B, it can be seen S₁₁ is now well matched at 2.6 GHz. S₁₂, S₂₁ cannot be shown as port 2 is open.

In FIG. 4A and FIG. 4B, the results are presented for when port 2 is left open, showing significant differences compared to FIG. 3A and FIG. 3B. Efficiency at 2.6 GHz is now nearly 95%. Port 1 is now matched with S₁₁ being less than-10 dB. These results have occurred because the adjacent port cannot return power induced by mutual coupling to its source. In FIG. 4A and FIG. 4B, it is also noted that S₁₂ and S₂₂ cannot be provided because port 2 is open. This is a subtle issue because the provided solution does not reduce mutual coupling. The mutual coupling remains the same as in FIG. 3A and FIG. 3B. However, the provided solution removes the effect of mutual coupling. Therefore, the measured efficiency is a main measure of how well the technique is performing. In this case, it has increased efficiency significantly as the effect of mutual coupling has been largely removed.

These exemplary results demonstrate that utilizing time modulation between adjacent ports can significantly reduce the effects of mutual coupling. Using this principle, further investigation is proposed to determine whether this approach can be useful in practice. Therefore, the following sections describe approaches to meet the objectives listed earlier.

### (II): Understanding System Tradeoffs for TMM Antennas

Using the design concept in “(I): Design Concept and Exemplary Results for TMM Antennas,” it is possible to significantly reduce the effect of mutual coupling. However, there are some system tradeoffs that need to be considered first. The first is the effect of time modulation on receiver power and the second is the effect of the harmonics generated by the switching. These are addressed in the following.

The first issue is the direct reduction in power received by ports being time modulated. If adjacent ports need to be time modulated as open, then there will be less received power at that port. Assuming that sets of adjacent antennas can be modulated open and “on” alternatively the port “on” time will be reduced by approximately half. This will cause 3 dB loss of received power.

The second issue is the reduction in received power caused by the harmonics generated from the switches. These harmonics can be removed by filtering at the receiver side but will consequently reduce the received power again. To quantify this, it can be approximately assumed 50% of the received power is lost to harmonics. This will cause an additional 3 dB power loss.

One of the key implications of the power reduction discussed in the previous two paragraphs is its effect on SNR and therefore capacity. The asymptotic expression for MIMO capacity under the condition of high SNR and equal numbers of transmit and receive antennas is as follows:

$$C \approx N {log}_{2} ( S N R ) = 0.33 N SNR [ dB ] \qquad Equation ( 2 )$$

where N is the number of transmit antennas. Assuming that TMM systems lose 6 dB of power compared to conventional systems, this would affect capacity. However, as seen from Equation (2), such a power loss does not alter the slope of the capacity line, which remains at N. The power loss only shifts the SNR. With an initial SNR of 30 dB, reduced to 24 dB (accounting for both switched and harmonic losses mentioned above), 25% more antennas are required to compensate for the 6 dB loss.

Although this may appear to require a substantial increase in the number of antennas, it is important to put it into perspective. For instance, in a massive MIMO array, using TMM and halving the inter-element spacing in each dimension would increase the number of antennas by a factor of 4, which far exceeds the impact of the 6 dB power reduction. To meet the requirement of 25% more antennas, reducing inter-element spacing by only 10% in each dimension would suffice. Thus, increased performance should still be achievable with the TMM approach, even when accounting for the power loss.

Although some preliminary results regarding the tradeoffs between TMM and conventional MIMO systems have been obtained, further analysis is necessary. First, the mutual coupling between every second element needs to be properly characterized and compared to adjacent elements to accurately assess the possible capacity gains. This involves using the full MIMO channel capacity model with mutual coupling effects. Additionally, a better understanding of time modulation effects is required. For instance, allowing some overlap between the open and on modulation states could reduce power loss, but it would also decrease the reduction in mutual coupling effects. This tradeoff needs to be thoroughly investigated, along with the inclusion of realistic switch harmonics in developing these tradeoffs. These issues will be addressed in the present invention.

### (III): Development of TMM Antenna Design Guidelines

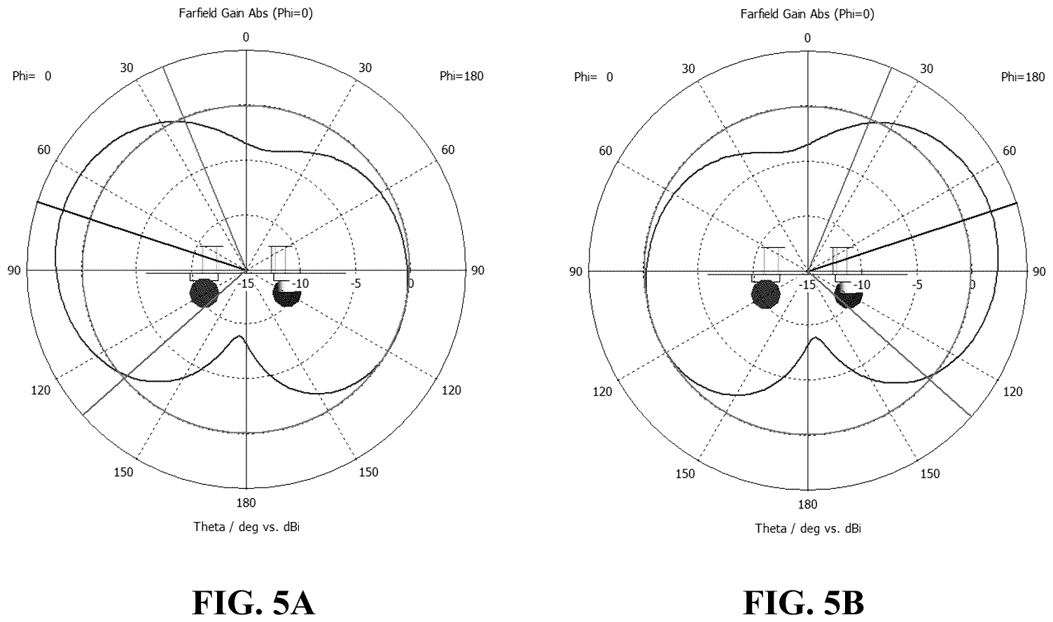

In principle TMM, antennas can be extremely close to each other with the effect of mutual coupling nearly completely removed. However, the patterns of the antennas of each of the elements will then also be nearly identical. This then leads to the question of whether channel correlation will be sufficiently small. For example, FIG. 5A and FIG. 5B show antenna patterns along x-z cut with both ports loaded. Specifically, FIG. 5A corresponds to port 1 (2.52 dBi) and FIG. 5B corresponds to port 2 (2.52 dBi). The patterns are different (with reflection symmetry due to symmetry in the antenna system) and will be different enough to exhibit low channel correlation. In FIG. 5A and FIG. 5B, the patterns for the antennas are shown when both antenna ports are loaded and fed normally. As can be seen the patterns are different. This difference will reduce channel correlation as it provides pattern diversity.

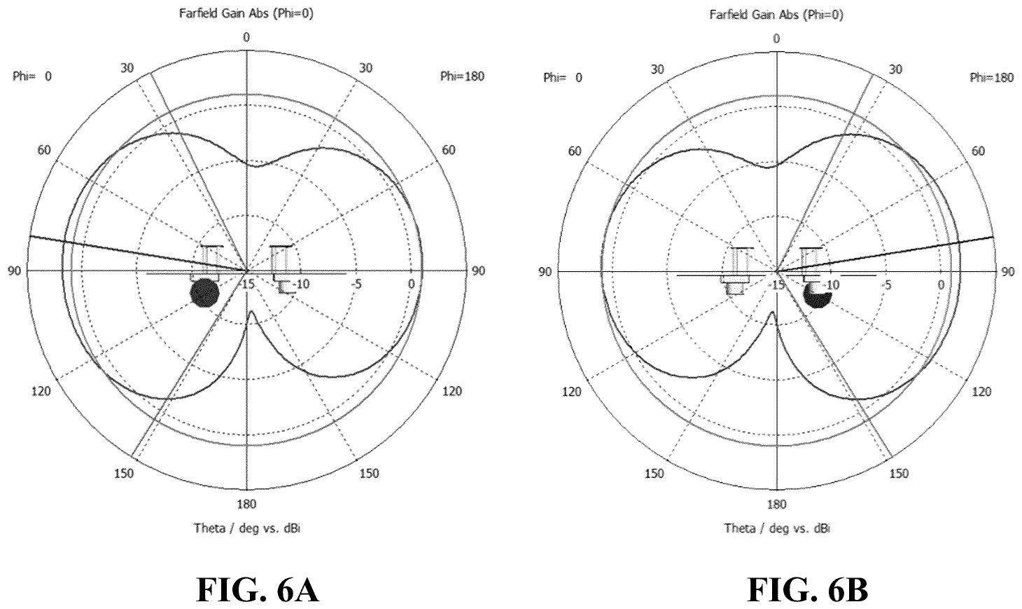

FIG. 6A and FIG. 6B show open circuit antenna patterns along x-z cut. Specifically, FIG. 6A correspond to port 1 pattern (1.77 dBi) with port 2 open circuited; and FIG. 6B corresponds to port 2 (1.77 dBi) pattern with port 1 open circuited. The patterns have fewer differences as compared to FIG. 5A and FIG. 5B and will exhibit more channel correlation.

The antenna patterns are provided for the case when the antennas are alternately time modulated, leaving the opposite port open. As observed, the patterns become more similar due to the removal of mutual coupling effects. However, the issue is that channel correlation becomes almost entirely dependent on the separation. Therefore, the channel correlation between two antennas separated by distance d will likely follow Jakes model which can be written, in terms of a Bessel function of the first kind, as:

$$ρ ( d ) = {J}_{o} ( kd ) \qquad Equation 3$$

where ρ(d) is the envelope correlation between the envelopes at port 1 and port 2, and k is wave number. It can be observed that separating the antennas will be necessary to reduce channel correlation, which directly conflicts with the TMM approach aimed at reducing antenna separation

To overcome these conflicts, it is therefore important that the patterns and/or polarization of adjacent antennas in TMM antenna design be different. If adjacent antennas are different, the correlation will not depend on the distance between antennas. It will depend on how different the patterns and/or polarization of the two antenna designs are. Therefore, an important design guideline for using the TMM concept is that adjacent antennas should have different patterns and/or polarization. In practice, this suggests that a massive MIMO array would have an interleaved structure. For mobile station antennas, it implies that adjacent antennas should be made as distinct as possible from one another.

In this task, the objective is therefore to identify pairs of antennas that can be easily interleaved while providing sufficient adjacent pattern diversity to reduce the effects of channel correlation. A fresh approach is needed to explore a wide range of antenna pair options for interleaving. Additionally, further investigation into the interleaved structure and pattern necessary to fully exploit this design concept is required.

### (IV): Development of Reconfigurable TMM Antennas

Two aspects of TMM antenna design make it perfectly suited for use with reconfigurable antenna designs. The first is that for any two adjacent antennas only one is ever radiating. The second is that the patterns of the adjacent antennas need to be different. It is therefore possible to combine the two adjacent elements into a single reconfigurable antenna with two states. At any one instant only one of the antennas would be time modulated on and the patterns of the two reconfigurable states could be made very different. This approach would also have the significant added advantage of requiring less RF front ends. That is only one RF front end could be used to handle each reconfigurable antenna instead of two. The tradeoff would be that the frontends would need to have at least twice the bandwidth.

The TMM antenna design challenge then becomes the design of reconfigurable antennas and the development of novel techniques to allow them to be closely spaced. If the reconfigurable antennas can be as closely spaced as in conventional MIMO antenna designs then in a two-dimensional (2D) planar configuration it would be possible to achieve a four times increase in antenna density. Even if dual-polarization antenna arrays are considered, a double of antenna density can be achieved. This would easily overcome the reduction in capacity associated with power loss as discussed in relation to Equation (2).

The objective of this task is to identify reconfigurable antennas and configurations that are compatible with TMM. While the design of these antennas can leverage a significant body of prior research, an additional challenge arises: ensuring low mutual coupling between adjacent antennas. As a result, it will be necessary to design antennas in pairs, allowing mutual coupling between them to be understood and controlled. For example, in one configuration, low mutual coupling may be required, while in another, higher coupling could be acceptable, as the antennas will not operate in that state simultaneously. Additionally, the interleaving approach mentioned earlier could be applied, where adjacent reconfigurable antennas have different structures. Another critical consideration is how to implement the reconfiguration process. While PIN diodes have been used in previous designs, they can consume significant power when controlling hundreds of antennas. Therefore, the potential for using alternative reconfigurable elements, such as varactors, are also be explored in this task according to some embodiments.

### (V): Investigation of Extensions to Transmit TMM Antenna Systems

In all the previous discussions, the target antenna designs have been assumed to be receiver systems. This is because the harmonics generated by the switching can be easily filtered out. Applying the proposed approach at the receiver also holds significant practical value, as the compact designs are particularly beneficial for mobile stations where space is limited. Consequently, this technique has the potential to enhance download speeds, addressing a common bottleneck in wireless communication.

Never-the-less extending this technique for transmission would also be very useful. To do so it is necessary to overcome the issue of the radiated harmonics. There has been significant effort in reducing harmonics as discussed in the review section. Special switching techniques have been developed with multiple phase and amplitude control.

The objective is to explore an alternative approach that has been proven effective for RF pulse shaping and orthogonal frequency division multiplexing (OFDM). This method involves systematic beam space decomposition along with electronically steerable parasitic array radiators (ESPAR) utilizing varactors. By smoothly varying the current at the varactors, virtually any pulse shape can be achieved. Applying this space-time approach to TMM antenna design for transmission systems could be a highly suitable solution. The pulse shaping technique based on varactors would allow for seamless reconfiguration from one beam shape to another, forming a reconfigurable element within the multiport antenna array, which would also reduce harmonics for transmission purposes.

In practical use, the proposed technical solution offers a general configuration for antennas. For example, a space-time multiport antenna system is provided with an antenna array, a plurality of feed ports, and a controller. The antenna array includes a plurality of antenna elements and the feed ports are connected to the antenna elements, respectively, so as to form a general base configuration. The controller can be applied to this general base configuration. The controller is connected to the antenna array via the feed ports and is configured to control the antenna elements for dynamically switching states of the antenna elements. Each pair of the adjacent antenna elements form a unit, and, in anyone of the units and at any given time, only one of the antenna elements is active and another one of the antenna elements is in a non-active state, which is advantageous to reduce mutual coupling of closely-spaced antennas significantly. The term “antenna array” mean it is formed by arranging the antenna elements into a N*M array, where N and M are positive integers greater than one.

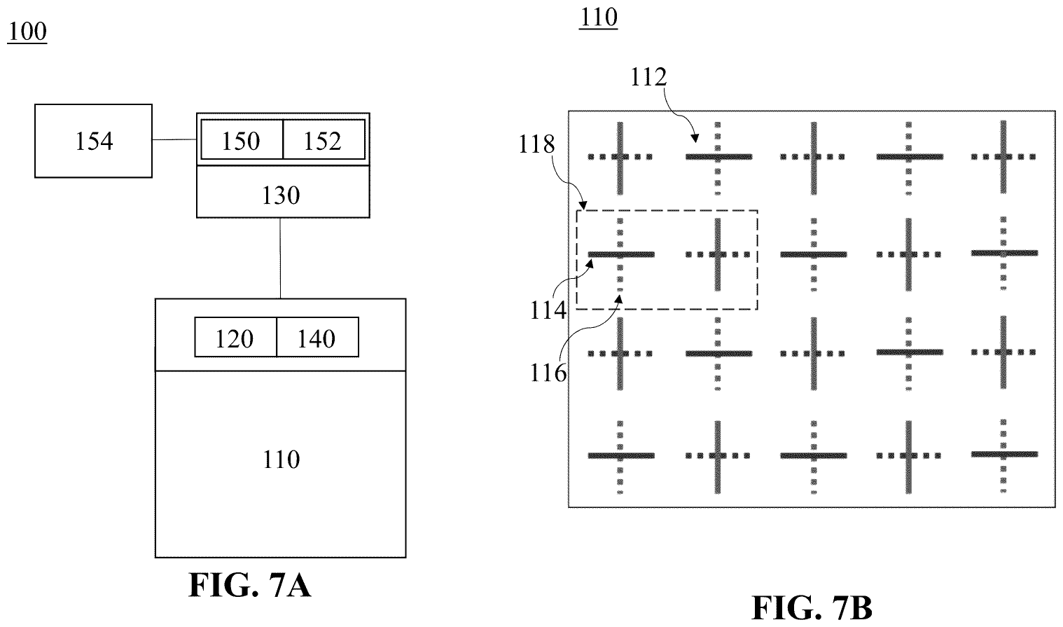

FIG. 7A depicts a schematic drawing of a space-time multiport antenna system 100 according to some embodiments of the present invention; and FIG. 7B depicts a schematic drawing of a dual-polarized antenna 110 during operation according to some embodiments of the present invention. In FIG. 7B, solid and dotted lines correspond to antennas turning “on” at different time points/intervals.

The space-time multiport antenna system 100 includes a dual-polarized antenna array 110, feed ports 120, a controller 130, variable capacitors 140, a single RF front end 150, a switch 152, and an RF control circuit 154.

The dual-polarized antenna array 110 includes a plurality of antenna elements 112 and it is formed by arranging the antenna elements 112 into a N*M array, wherein N and M are positive integers greater than one; for example, the array in FIG. 7B is a 4*5 antenna array, with antenna elements 112 arranged at each position in the array. Each of the antenna elements 112 is in a crossed dipole structure and includes a first dipole element 114 extending horizontally along a first axis direction (e.g., the horizontal direction in FIG. 7B) a second dipole element 116 extending vertically along a second axis direction (e.g., the vertical direction in FIG. 7B), forming an orthogonal configuration at their intersection.

In each of the antenna elements 112, the first dipole element 114 is made of a conductive material aligned along a horizontal plane and the second dipole element 116 is made of a conductive material aligned along a vertical plane, with the first dipole element 114 and the second dipole element 116 being spatially intersecting but electrically isolated. For example, the space-time multiport antenna system 100 may include a dielectric frame, and the crossed first dipole elements 114 and the second dipole elements 116 are supported by the dielectric frame, providing mechanical stability and maintaining electrical isolation between the first dipole elements 114 and the second dipole elements 116. For the sake of simplifying the description and explanation, each pair of the adjacent antenna elements 112 form a unit 118.

The feed ports 120 serve as connection points in an antenna system 100 that supply power to or receive signals from the antenna elements 112. The feed ports 120 allow for signal transmission and reception, enabling control of different polarizations, such as horizontal and vertical. Each of the first dipole elements 112 and the second dipole elements 114 is connected to a corresponding one of the feed ports 120, enabling independent transmission and reception of horizontally or vertically polarized signals.

The controller 130 is connected to the dual-polarized antenna array 110 via the feed ports 120 and is configured to control the antenna elements 112 of the dual-polarized antenna array 110 for dynamically switching states of the antenna elements 112. In single unit (e.g., the unit 118), the two of the adjacent antenna elements 112 are active at any given time, but their respective dipole elements operate in differing states.

Specifically, for the adjacent antenna elements 112 in the single unit 118, at a given time point, the left one of the first dipole elements 114 is in an active state and the right one of the first dipole elements 114 is in a non-active state; similarly, the right one of the second dipole elements 116 is in an active state and the left one of the second dipole elements 116 is in a non-active state. Also, in the next time point, the left one of the first dipole elements 114 is in a non-active state and the right one of the first dipole elements 114 is in an active state; similarly, the right one of the second dipole elements 116 is in a non-active state and the left one of the second dipole elements 116 is in an active state. As such, the antenna elements are alternately time modulated.

In some embodiments, the variable capacitors 140 are connected to the first dipole elements 114 and second dipole elements 116 of the dual-polarized antenna array 110 via the feed ports 120 and configured to receive control signals from the controller 130 to adjust capacitance of each of the first dipole elements 114 and the second dipole elements 116 based on operational requirements, enabling adaptive radiation characteristics. Accordingly, a configuration of the first dipole elements 114 and the second dipole elements 116 in combination with the variable capacitors 140 allows for smooth reconfiguration of a radiation pattern, dynamically shifting from one beam shape to another through modulation of the variable capacitors 140.

In some embodiments, the RF front end 150 is connected to both the first dipole element 114 and the second dipole element 116 of the crossed dipole structure. The RF front end 150 at least includes an RF amplifier connected to both the first dipole element 114 and the second dipole element 116 and is configured to amplify received RF signals from both the first dipole element 114 and the second dipole element 116. The switch 152 is connected to the RF amplifier and is configured to route signals between the first and second dipole elements 114, 116, and the RF front end 150 during transmission and reception modes. The RF control circuit 154 is coupled to the RF front end 150 and is configured to manage the RF front end's operation by adjusting gain, frequency, and switching functions.

Briefly, during the operation, there are primarily two steps. The first one is feeding horizontally or vertically polarized signals to the dual-polarized antenna array 110 via feed ports 120; and the second one is controlling the dual-polarized antenna array 110 using the controller 130 via the feed ports 120 for dynamically switching states of the antenna elements, such that the two of the adjacent antenna elements 112 in the unit are active at any given time, but their respective dipole elements operate in differing states.

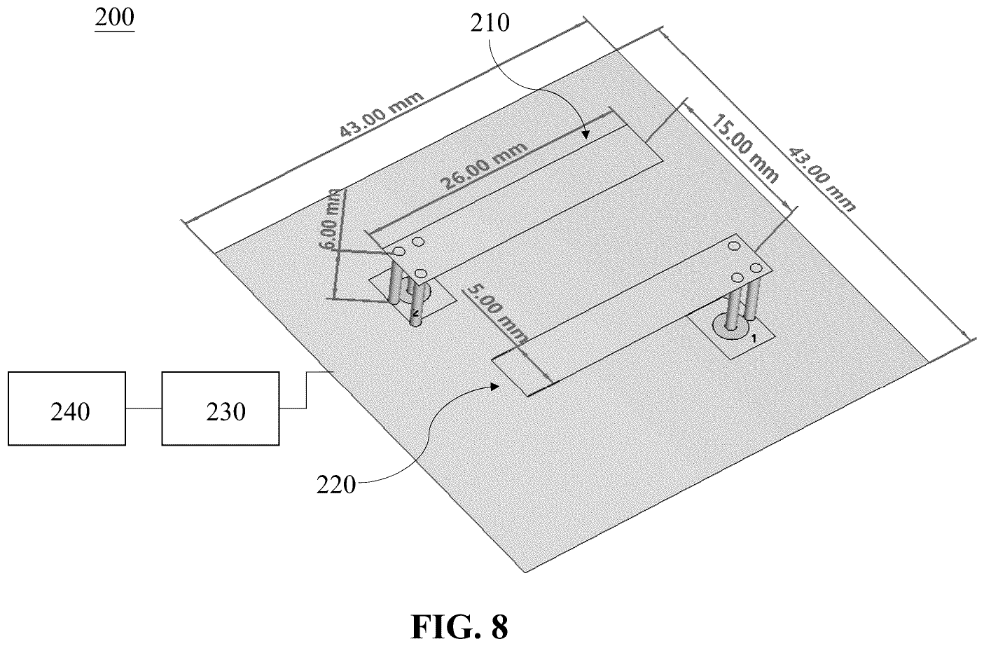

Furthermore, this control architecture can be applied to a planar inverted-F antenna system. For example, FIG. 8 depicts a schematic drawing of a planar inverted-F antenna system 200 according to some embodiments of the present invention. The planar inverted-F antenna system 200 includes a first PIFA element 210, a second PIFA element 220, at least one feed pin 230, and a controller 240. The first PIFA element 210 and the second PIFA element 220 are arranged in parallel. The first PIFA element 210 extends in a first direction and the second PIFA element 220 extends in a second direction opposite to the first direction (e.g., right and left directions). In other embodiments, the first PIFA element 210 and the second PIFA element 220 are arranged in parallel and extend in the same direction.

The feed pin 230 is electrically connected to the first and second PIFA elements 210, 220. The feed pin 230 is configured to receive or transmit signals for the first and second PIFA elements 210, 220. The controller 240 is connected to the first and second PIFA elements 210, 220 via the feed pin 230 and is configured to dynamically control an operational state for the first and second PIFA elements 210 220. As such, at a first time point, the first PIFA element 210 is active and the second PIFA element 220 remains inactive, and, at a second time point, the second PIFA element 220 is active and the first PIFA element 210 remains inactive, allowing for controlled switching between the first and second PIFA elements 210, 220 based on time-modulated operation. Accordingly, dynamic time-modulated control through the controller allows the two PIFA elements to be positioned closer together, thereby increasing the antenna element density.

In conclusion, a novel solution for the design of space-time multiport antennas suitable for enhancing MIMO communications is provided. The objective of this invention is to utilize space-time antenna design techniques to introduce novel multiport antennas that enhance wireless communication performance. The key innovation lies in exploiting time modulation within the antenna to substantially reduce mutual coupling. This approach has the potential to quadruple the number of antennas in a two-dimensional area without breaching fundamental limits. By incorporating time as a fourth dimension in multiport antenna design, new possibilities for improved wireless communication performance may be unlocked.

Although the above embodiments use dual-polarized antennas and PIFA antennas for examples, the present invention is not limited to these. The proposed controller can also be applied to other types of antennas, providing a general technique to reduce mutual coupling of closely-spaced antennas significantly. Specifically, for antenna elements that need to be arranged in an array, they can be operated through a controller capable of dynamically switching the states of the antenna elements (which is proposed as afore-described), forming a space-time multiport configuration, which allows the spacing between the antenna elements to be reduced.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A space-time multiport antenna system, comprising:
an antenna array comprising a plurality of antenna elements;
a plurality of feed ports connected to the antenna elements, respectively; and
a controller connected to the antenna array via the feed ports and configured to control the antenna elements for dynamically switching states of the antenna elements, wherein each pair of the adjacent antenna elements form a unit, and, in anyone of the units and at any given time, only one of the antenna elements is active and another one of the antenna elements is in a non-active state.

2. The space-time multiport antenna system of claim 1, wherein the antenna array is formed by arranging the antenna elements into a N*M array, wherein N and M are positive integers greater than one.

3. A space-time multiport antenna system, comprising:
a dual-polarized antenna array comprising a plurality of antenna elements, wherein each of the antenna elements is in a crossed dipole structure and comprises a first dipole element extending horizontally along a first axis direction and a second dipole element extending vertically along a second axis direction, forming an orthogonal configuration at their intersection, wherein, in each of the antenna elements, the first dipole element is made of a conductive material aligned along a horizontal plane and the second dipole element is made of a conductive material aligned along a vertical plane, with the first dipole element and the second dipole element being spatially intersecting but electrically isolated;
a plurality of feed ports, wherein each of the first dipole elements and the second dipole elements is connected to a corresponding one of the feed ports, enabling independent transmission and reception of horizontally or vertically polarized signals; and
a controller connected to the dual-polarized antenna array via the feed ports and configured to control the antenna elements for dynamically switching states of the antenna elements, wherein each pair of the adjacent antenna elements form a unit and the two of the adjacent antenna elements in the unit are active at any given time, but their respective dipole elements operate in differing states.

4. The space-time multiport antenna system of claim 3, wherein, in the adjacent antenna elements in the unit, one of the first dipole elements is in an active state and another one of the first dipole elements is in a non-active state, and one of the second dipole elements is in an active state and another one of the second dipole elements is in a non-active state, at a given time point.

5. The space-time multiport antenna system of claim 3, wherein the dual-polarized antenna array is formed by arranging the antenna elements into a N*M array, wherein N and M are positive integers greater than one.

6. The space-time multiport antenna system of claim 3, further comprising:
a plurality of variable capacitors connected to the first dipole elements and second dipole elements of the dual-polarized antenna array via the feed ports and configured to receive control signals from the controller to adjust capacitance of each of the first dipole elements and second dipole elements based on operational requirements, enabling adaptive radiation characteristics, wherein a configuration of the first dipole elements and the second dipole elements in combination with the variable capacitors allows for smooth reconfiguration of a radiation pattern, dynamically shifting from one beam shape to another through modulation of the variable capacitors.

7. The space-time multiport antenna system of claim 3, further comprising:
a dielectric frame, wherein the crossed first dipole elements and the second dipole elements are supported by the dielectric frame, providing mechanical stability and maintaining electrical isolation between the first dipole elements and the second dipole elements.

8. The space-time multiport antenna system of claim 3, further comprising:
a single RF front end connected to both the first dipole element and the second dipole element of the crossed dipole structure, wherein the RF front end comprises at least one RF amplifier connected to both the first dipole element and the second dipole element and configured to amplify received RF signals from both the first dipole element and the second dipole element;
a switch connected to the RF amplifier and configured to route signals between the first and second dipole elements and the RF front end during transmission and reception modes; and
an RF control circuit coupled to the RF front end and configured to manage the RF front end's operation by adjusting gain, frequency, and switching functions.

9. A method for operating the space-time multiport antenna system of claim 3, comprising:
feeding horizontally or vertically polarized signals to a dual-polarized antenna array via feed ports, wherein the dual-polarized antenna array comprises a plurality of antenna elements, each of the antenna elements is in a crossed dipole structure and comprises a first dipole element extending horizontally along a first axis direction and a second dipole element extending vertically along a second axis direction, forming an orthogonal configuration at their intersection, and wherein each pair of the adjacent antenna elements form a unit; and
controlling the dual-polarized antenna array using the controller via the feed ports for dynamically switching states of the antenna elements, such that the two of the adjacent antenna elements in the unit are active at any given time, but their respective dipole elements operate in differing states.

10. The method of claim 9, wherein, in the adjacent antenna elements in the unit, one of the first dipole elements is in an active state and another one of the first dipole elements is in a non-active state, and one of the second dipole elements is in an active state and another one of the second dipole elements is in a non-active state, at a given time point.

11. The method of claim 9, wherein the dual-polarized antenna array is formed by arranging the antenna elements into a N*M array, wherein N and M are positive integers greater than one.

12. An antenna system, comprising:
a first planar inverted-F antenna (PIFA) element and a second PIFA element arranged in parallel, wherein the first PIFA element extends in a first direction and the second PIFA element extends in a second direction opposite to the first direction;
at least one feed pin electrically connected to the first and second PIFA elements, wherein the feed pin is configured to receive or transmit signals for the first and second PIFA elements; and
a controller connected to the first and second PIFA elements via the feed pin and configured to dynamically control an operational state for the first and second PIFA elements, such that, at a first time point, the first PIFA element is active and the second PIFA element remains inactive, and that, at a second time point, the second PIFA element is active and the first PIFA element remains inactive, allowing for controlled switching between the first and second PIFA elements based on time-modulated operation.
